(19) United States
(12) Patent Application Publication
(10) Pub. No.: US 2013/0126051 A1
(43) Pub. Date: May 23, 2013

(54) ALUMINUM ALLOY CONDUCTOR

(71) Applicants: Furukawa Electric Co., Ltd., Tokyo (JP); Furukawa Automotive Systems Inc., Shiga (JP)

(72) Inventors: Shigeki SEKIYA, Tokyo (JP); Kyota SUSAI, Tokyo (JP)

(73) Assignees: FURUKAWA AUTOMOTIVE SYSTEMS INC., Shiga (JP); FURUKAWA ELECTRIC CO., LTD., Tokyo (JP)

(21) Appl. No.: 13/740,910

(22) Filed: Jan. 14, 2013

Related U.S. Application Data
(63) Continuation of application No. PCT/JP2011/066258, filed on Jul. 15, 2011.

(30) Foreign Application Priority Data
Jul. 15, 2010 (JP) 2010-161116

(51) Int. Cl. H01B 1/02; C22F 1/047; C22F 1/04; C22F 1/043; C22F 1/057

(52) U.S. Cl. CPC H01B 1/023; C22F 1/043; C22F 1/057; C22F 1/04; C22F 1/047
USPC 148/502; 148/439

(57) ABSTRACT

An aluminum alloy conductor, which has a specific aluminum alloy composition of Al—Fe—Mg—Si—Cu—(TiN), Al—Fe, Al—Fe—Mg—Si, or Al—Fe—Mg—Si—Cu, which has a recrystallized texture of 40% or more of an area ratio of grains each having a (111) plane and being positioned in parallel to a cross-section vertical to a wire-drawing direction of a wire, and which has a grain size of 1 to 30 μm on the cross-section vertical to the wire-drawing direction of the wire; and a production method thereof.

### TECHNICAL FIELD

The present invention relates to an aluminum alloy conductor that is used as a conductor of an electrical wiring.

### BACKGROUND ART

Hitherto, a member in which a terminal (connector) made of copper or a copper alloy (for example, brass) is attached to electrical wires comprised of conductors of copper or a copper alloy, which is called a wire harness, has been used as an electrical wiring for movable bodies, such as automobiles, trains, and aircrafts. In weight reduction of movable bodies in recent years, studies have been progressing on use of aluminum or an aluminum alloy that is lighter than copper or a copper alloy, as a conductor for the electrical wiring.

The specific gravity of aluminum is about one-third of that of copper, and the electrical conductivity of aluminum is about two-thirds of that of copper (when pure copper is considered as a criterion of 100% IACS, pure aluminum has about 66% IACS). Therefore, in order to pass an electrical current through a conductor wire of pure aluminum, in which the intensity of the current is identical to that through a conductor wire of pure copper, it is necessary to adjust the cross-sectional area of the conductor wire of pure aluminum to about 1.5 times larger than that of the conductor wire of pure copper, but aluminum conductor wire is still more advantageous in mass than copper conductor wire in that the former has an about half weight of the latter.

Herein, the term “% IACS” mentioned above represents an electrical conductivity when the resistivity 1.7241×10⁻⁸ Ωm of International Annealed Copper Standard is defined as 100% IACS.

There are some problems in using the aluminum as a conductor of an electrical wiring for movable bodies. One of the problems is improvement in resistance to bending fatigue. This is because a repeated bending stress is applied to a wire harness attached to a door or the like, due to opening and closing of the door. A metal material, such as aluminum, is broken at a certain number of times of repeating of applying a load when the load is applied to or removed repeatedly as in opening and closing of a door, even at a low load at which the material is not broken by one time of applying the load thereto (fatigue breakage). When the aluminum conductor is used in an opening and closing part, if the conductor is poor in resistance to bending fatigue, it is concerned that the conductor is broken in the use thereof, to result in a problem of lack of durability and reliability.

In general, it is considered that as a material is higher in mechanical strength, it is better in fatigue property. Thus, it is preferable to use an aluminum conductor high in mechanical strength. On the other hand, since a wire harness is required to be readily in wire-running (i.e. an operation of attaching of it to a vehicle body) in the installation thereof, an annealed material is generally used in many cases, by which 10% or more of tensile elongation at breakage can be ensured.

According to the above, for an aluminum conductor that is used in an electrical wiring of a movable body, a material is required, which is excellent in mechanical tensile strength that is required in handling and attaching, and which is excellent in electrical conductivity that is required for passing much electricity, as well as which is excellent in resistance to bending fatigue.

For applications for which such a demand is exist, ones of pure aluminum-systems represented by aluminum alloy wires for electrical power lines (JIS A1060 and JIS A1070) cannot sufficiently tolerate a repeated bending stress that is generated by opening and closing of a door or the like. Further, although an alloy in which various additive elements are added is excellent in mechanical strength, the alloy has problems that the electrical conductivity is lowered due to solid-solution phenomenon of the additive elements in aluminum, and wire breaking occurs in wire-drawing due to formation of excess intermetallic compounds in aluminum. Therefore, it is necessary to limit and select additive elements, to prevent breakage as an essential feature, to prevent lowering in electrical conductivity, and to enhance mechanical strength and resistance to bending fatigue.

Typical aluminum conductors used in electrical wirings of movable bodies include those described in Patent Literatures 1 to 4. However, the electrical wire conductor described in Patent Literature 1 is too high in tensile strength, and thus an operation of attaching it to a vehicle body may become difficult in some cases. The conductor described in Patent Literature 2 has undergone a continuous heat treatment by passing current, and Patent Literature 2 has some descriptions on a temperature and a time period as conditions for the heat treatment, but there is a room to study further in detail. Furthermore, Sb, which is one of the constitutional elements, is considered as a substance of concern (an environmentally hazardous substance), and substitution with an alternate product is required. The aluminum conductive wire that is specifically described in Patent Literature 3 has not undergone any finish annealing. An aluminum conductive wire having higher flexibility is required for an operation of attaching it to a vehicle body. Patent Literature 4 discloses an aluminum conductive wire that is light, flexible and excellent in bending property, but demands for improvement of characteristics of electrical wirings for movable bodies have only become stronger, and there is a demand on further improvement of the properties.

### CITATION LIST

### Patent Literatures

Patent Literature 1: JP-A-2008-112620 (“JP-A” means unexamined published Japanese patent application)
Patent Literature 2: JP-B-55-45626 (“JP-B” means examined Japanese patent publication)
Patent Literature 3: JP-A-2006-19163
Patent Literature 4: JP-A-2006-253109

### SUMMARY OF INVENTION

### Technical Problem

The present invention is contemplated for providing an aluminum alloy conductor, which has sufficient electrical conductivity and tensile strength, and which is excellent in resistance to bending fatigue.

### Solution to Problem

The inventors of the present invention, having studied keenly, found that an aluminum alloy conductor, which has excellent resistance to bending fatigue, mechanical strength, and electrical conductivity, can be produced, by controlling a recrystallized texture by controlling the production conditions, such as a working degree before a heat treatment of an aluminum alloy and those in a continuous heat treatment. The present invention is attained based on that finding.

That is, according to the present invention, there is provided the following means:

(1) An aluminum alloy conductor, which has a recrystallized texture of 40% or more of an area ratio of grains each having a (111) plane and being positioned in parallel to a cross-section vertical to a wire-drawing direction of a wire, and which has a grain size of 1 to 30 μm on the cross-section vertical to the wire-drawing direction of the wire.
(2) The aluminum alloy conductor according to (1), which has the recrystallized texture of 25% or more of the area ratio of grains each having a (111) plane and being positioned in parallel to the cross-section vertical to the wire-drawing direction of the wire, and of 25% or more of an area ratio of grains each having a (112) plane and being positioned in parallel to the cross-section vertical to the wire-drawing direction of the wire, in an area formed by removing, from the entirety of the wire, a portion included in a circle with a radius of (9/10)R from the center of the wire on the cross-section vertical to the wire-drawing direction of the wire, in which R is a radius of the wire.
(3) The aluminum alloy conductor according to (1) or (2), which is produced by: subjecting to wire-drawing at a working degree from 1 to 6, and then subjecting to a continuous electric heat treatment that is a continuous heat treatment comprising the steps of: rapid heating, and quenching, in which a wire temperature y (° C.) and an annealing time period x (sec) satisfy relationships of:

0.03≦x≦0.55, and

26x^{-0.6}+377≦y≦23.5x^{-0.6}+423.

(4) The aluminum alloy conductor according to (1) or (2), which is produced by: subjecting to wire-drawing at a working degree from 1 to 6, and then subjecting to a continuous running heat treatment that is a continuous heat treatment comprising the steps of: rapid heating, and quenching, in which an annealing furnace temperature z (° C.) and an annealing time period x (sec) satisfy relationships of:

1.5≦x≦5, and

−50x+550≦z≦36x+650.

(5) The aluminum alloy conductor according to any one of (1) to (4), containing: 0.01 to 0.4 mass % of Fe, 0.1 to 0.3 mass % of Mg, 0.04 to 0.3 mass % of Si, 0.1 to 0.5 mass % of Cu, and further containing 0.001 to 0.01 mass % of Ti and V in total, with the balance being Al and inevitable impurities.
(6) The aluminum alloy conductor according to any one of (1) to (4), containing: 0.4 to 1.5 mass % of Fe, with the balance being Al and inevitable impurities.
(7) The aluminum alloy conductor according to any one of (1) to (4), containing: 0.4 to 1.5 mass % of Fe, 0.1 to 0.3 mass % of Mg, and 0.04 to 0.3 mass % of Si, with the balance being Al and inevitable impurities.
(8) The aluminum alloy conductor according to any one of (1) to (4), containing: 0.01 to 0.5 mass % of Fe, 0.3 to 1.0 mass % of Mg, 0.3 to 1.0 mass % of Si, and 0.01 to 0.2 mass % of Cu, with the balance being Al and inevitable impurities.
(9) The aluminum alloy conductor according to any one of (1) to (8), which is used as a conductor wire for a battery cable, a harness, or a motor, in a movable body.
(10) The aluminum alloy conductor according to (9), wherein the movable body is an automobile, a train, or an aircraft.

### Advantageous Effects of Invention

The aluminum alloy conductor of the present invention is excellent in the mechanical strength and the electrical conductivity, and is useful as a conductor wire for a battery cable, a harness, or a motor, each of which is mounted on a movable body, and thus can also be preferably used for a door, a trunk, a hood (or a bonnet), and the like, for which a quite high resistance to bending fatigue is required.

Other and further features and advantages of the invention will appear more fully from the following description, appropriately referring to the accompanying drawings.

### BRIEF DESCRIPTION OF THE DRAWINGS

FIG. 1 is an explanatory view showing an area formed by removing, from the entirety of a wire, a portion included in a circle with a radius of 9/10R from the center of the wire on the cross-section vertical to the wire-drawing direction of the wire.

FIG. 2 is an explanatory view of the test for measuring the number of repeating times at breakage, which was conducted in the Examples.

### MODE FOR CARRYING OUT THE INVENTION

The aluminum alloy conductor of the present invention can have both excellent resistance to bending fatigue, and sufficient flexibility, mechanical strength, and electrical conductivity, by defining the recrystallized texture as follows.

### (Recrystallized Texture)

In the present invention, the recrystallized texture is defined by using a crystal plane viewed from the wire-drawing direction. The recrystallized texture refers to a microstructure constituted by polycrystalline grains in which many grains in a certain crystalline orientation are aggregated, which can be obtained in the course of recrystallization. The recrystallized texture of the aluminum alloy conductor of the present invention has 40% or more of an area ratio of grains each having a (111) plane and being positioned in parallel to a cross-section vertical to a wire-drawing direction of a wire. More preferably, the recrystallized texture has 25% or more of the area ratio of grains each having a (111) plane and being positioned in parallel to the cross-section vertical to the wire-drawing direction of the wire, and has 25% or more of an area ratio of grains each having a (112) plane and being positioned in parallel to the cross-section vertical to the wire-drawing direction of the wire, in an area formed by removing, from the entirety of the wire, a portion included in a circle with a radius of (9/10)R from the center of the wire on the cross-section vertical to the wire-drawing direction of the wire, in which R is a radius of the wire. By providing such a recrystallized texture, when the wire is bent, as shown in FIG. 2, to the wire-drawing direction, the grains having a (111) plane and the grains having a (112) plane can improve the resistance to bending fatigue. It is particularly preferable to conduct the texture controlling of the surface layer portion, since occurrence of fatigue cracks can be suppressed and the resistance to bending fatigue can further be improved, by controlling the texture of the surface layer portion.

The area ratio in each crystal orientation in the present invention is a value measured by the EBSD method. The EBSD method is an abbreviation of Electron Back Scatter Diffraction, and refers to a technique to analyze a crystal orientation utilizing refractive electron Kikuchi-line diffraction that is generated when a sample is irradiated with electron beam in a scanning electron microscope (SEM). The area ratio in each orientation is the ratio, to the whole measured area, of the area of grains that are inclined within the range of ±10° from an ideal crystal plane, such as a (111) plane and a (112) plane. Although the information obtained in the orientation analysis by EBSD includes orientation information up to a depth of several ten nanometers to which electron beam penetrates into the sample, the information is handled as an area ratio in the present specification, since the depth is sufficiently small to the area measured.

As mentioned below in detail, the aluminum alloy conductor of the present invention that is prepared by suitably conducting a heat treatment, is in an aggregate state (aggregate microstructure) of grains each having the above-mentioned predetermined plane, and also it has a recrystallized microstructure. The recrystallized microstructure refers to a microstructural state that is constituted by grains being less in lattice defects, such as dislocations, introduced by plastic working. Since the aluminum alloy conductor has the recrystallized microstructure, the tensile elongation at breakage and electrical conductivity are recovered, and sufficient flexibility can be obtained.

### (Grain Size)

In the present invention, the aluminum wire has a grain size of 1 to 30 μm in a cross-section vertical to the wire-drawing direction. When the grain size is too small, not only a partially un-recrystallized microstructure remains and the target recrystallized texture cannot be obtained, but also the elongation is lowered conspicuously. When the grain size is too large and a coarse structure is formed, deformation behavior becomes uneven, the elongation is lowered similar to the above case of too small grain size, and further the mechanical strength is lowered conspicuously. The grain size is more preferably from 1 to 20 μm.

The “grain size” in the present invention is an average grain size obtained by conducting a grain size measurement with an intersection method by observing with an optical microscope, and is an average value of 50 to 100 grains.

Obtainment of an aluminum alloy conductor having such the recrystallized texture and grain size can be attained, by setting the alloy composition as follows, and by controlling the working degree (or the degree of working) before the continuous heat treatment, the conditions in the continuous heat treatment, and the like, as follows. Preferable production method and alloy compositions will be mentioned below.

### (Production Method)

The aluminum alloy conductor of the present invention can be produced via steps of: [1] melting, [2] casting, [3] hot- or cold-working (e.g. caliber rolling with grooved rolls), [4] wire drawing, [5] heat treatment (intermediate annealing), [6] wire drawing, and [7] heat treatment (finish annealing).

The melting is conducted by melting predetermined alloying elements each at a given content that gives the given concentration of each embodiment of the aluminum alloy composition mentioned below.

Then, the resultant molten metal is rolled while the molten metal is continuously cast in a water-cooled casting mold, by using a Properzi-type continuous cast-rolling machine which has a casting ring and a belt in combination, to give a rod of about 10 mm in diameter. The cooling speed in casting at that time is 1 to 20° C./sec. The casting and hot rolling may be conducted by billet casting, extrusion, or the like.

Then, surface stripping of the resultant rod is conducted to adjust the diameter to 9 to 9.5 mm, and the thus-stripped rod is subjected to wire drawing. The working degree is preferably from 1 to 6. Herein, the working degree η is represented by: η=In(A₀/A₁), in which the cross-sectional area of the wire (or rod) before the wire drawing is represented by A₀, and the cross-sectional area of the wire after the wire drawing is represented by A₁. If the working degree is too small, in the heat treatment in the subsequent step, the recrystallized grains may be coarsened to conspicuously lower the mechanical strength and elongation, which is a cause of wire breakage. If the working degree is too large, the wire drawing may become difficult, which is problematic in the quality in that, for example, wire breakage occurs in the wire drawing. Although the surface of the wire (or rod) is cleaned up by conducting surface stripping, the surface stripping may be omitted.

The thus-worked product that has undergone cold-wire drawing (i.e. a roughly-drawn wire), is subjected to intermediate annealing. The intermediate annealing is mainly conducted for recovering the flexibility of a wire that has been hardened by wire drawing. In the case where the intermediate annealing temperature is too high or too low, which result in that wire breakage may occur in the later wire drawing, to fail to obtain a wire. The intermediate annealing temperature is preferably 300 to 450° C., more preferably 350 to 450° C. The time period for intermediate annealing is 10 min or more. If the time period is less than 10 min, the time period required for the formation and growth of recrystallized grains is insufficient, and thus the flexibility of the wire cannot be recovered. The time period is preferably 1 to 6 hours. Furthermore, although the average cooling speed from the heat treatment temperature in the intermediate annealing to 100° C. is not particularly defined, it is preferably 0.1 to 10° C./min.

The thus-annealed roughly-drawn wire is further subjected to wire drawing. Also at this time, the working degree (the working degree before the continuous heat treatment) is set to be from 1 to 6, to obtain the above-mentioned recrystallized texture. The working degree has a significant influence on the formation and growth of recrystallized grains. If the working degree is too small, in the heat treatment in the subsequent step, the recrystallized grains may be coarsened to conspicuously lower the mechanical strength and elongation, which is a cause of wire breakage. Furthermore, the target recrystallized texture may not be formed due to insufficient driving force for a recrystallized grain boundary to migrate. If the working degree is too large, the wire drawing may become difficult, which is problematic in the quality in that, for example, wire breakage occurs in the wire drawing. The working degree is preferably from 2 to 6.

Further, the wire-drawing speed is controlled, to obtain the target recrystallized texture. The wire-drawing speed is preferably set to 500 to 2,000 m/min. When the wire-drawing speed is less than 500 m/min, it is highly possible that the target recrystallized texture cannot be obtained upon the finish annealing in the subsequent step. When the wire-drawing speed is more than 2,000 m/min, the friction force applied to the wire is high, and thus not only that it is highly possible that the target recrystallized texture cannot be obtained upon the finish annealing in the subsequent step, but also that a problem in view of quality, such as wire breakage in wire drawing, may arise. The wire-drawing speed is more preferably 800 to 1,800 m/min.

The thus-worked product that has undergone cold-wire drawing (i.e. a drawn wire), is subjected to finish annealing by continuous heat treatment. The continuous heat treatment can be conducted by either of the two methods: continuous electric heat treatment or continuous running heat treatment.

The continuous electric heat treatment is conducted through annealing by the Joule heat generated from the wire in interest itself that is running continuously through two electrode rings, by passing an electrical current through the wire. The continuous electric heat treatment has the steps of: rapid heating; and quenching, and can conduct annealing of the wire, by controlling the temperature of the wire and the time period for the annealing. The cooling is conducted, after the rapid heating, by continuously passing the wire through water or a nitrogen gas atmosphere. In one of or both of the case where the wire temperature in annealing is too low or too high and the case where the annealing time period is too short or too long, the target recrystallized texture cannot be obtained. Furthermore, in one of or both of the case where the wire temperature in annealing is too low and the case where the annealing time period is too short, the flexibility that is required for attaching the resultant wire to vehicle to mount thereon cannot be obtained; and, on the other hand, in one of or both of the case where the wire temperature in annealing is too high and in the case where the annealing time period is too long, the crystal orientation excessively rotates due to excess annealing, resulting in that the target recrystallized texture cannot be obtained, and further that the resistance to bending fatigue also becomes worse. Thus, the above-mentioned desired recrystallized texture can be formed, by conducting the continuous electric heat treatment under the conditions satisfying the following relationships.

Namely, when a wire temperature is represented by y (° C.) and an annealing time period is represented by x (sec), the continuous electric heat treatment is conducted under the conditions that satisfy:

0.03≦x≦0.55, and

26x^{-0.6}+377≦y≦23.5x^{-0.6}+423.

The wire temperature y (° C.) represents the temperature of the wire immediately before passing through the cooling step, at which the temperature of the wire is the highest. The y (° C.) is generally within the range of 414 to 616 (° C.).

The continuous running heat treatment is a treatment in which the wire is annealed by continuously passing through an annealing furnace maintained at a high temperature. The continuous running heat treatment has the steps of: rapid heating; and quenching, and can conduct annealing of the wire, by controlling the temperature of the annealing furnace and the time period for the annealing. The cooling is conducted, after the rapid heating, by continuously passing the wire through water or a nitrogen gas atmosphere. In one of or both of the case where the annealing furnace temperature is too low or too high and the case where the annealing time period is too short or too long, the target recrystallized texture cannot be obtained. Furthermore, in one of or both of the case where the annealing furnace temperature is too low and the case where the annealing time period is too short, the flexibility that is required for attaching the resultant wire to vehicle to mount thereon cannot be obtained; and, on the other hand, in one of or both of the case where the annealing furnace temperature is too high and in the case where the annealing time period is too long, the crystal orientation excessively rotates due to excess annealing, resulting in that the target recrystallized texture cannot be obtained, and further that the resistance to bending fatigue also becomes worse. Thus, the above-mentioned desired recrystallized texture can be formed, by conducting the continuous running heat treatment under the conditions satisfying the following relationships.

Namely, when an annealing furnace temperature is represented by z (° C.) and an annealing time period is represented by x (sec), the continuous running heat treatment is conducted under the conditions that satisfy:

1.5≦x≦5, and

−50x+550≦z≦36x+650.

The annealing furnace temperature z (° C.) represents the temperature of the annealing furnace immediately before passing the wire through the cooling step, at which the temperature of the wire is the highest. The z (° C.) is generally within the range of 300 to 596 (° C.).

Furthermore, besides the above-mentioned two methods, the finish annealing may be induction heating by which the wire is annealed by continuously passing through a magnetic field.

### (Alloy Composition)

A preferable first embodiment of the present invention has an alloy composition (i.e. a structure of alloying elements), which contains 0.01 to 0.4 mass % of Fe, 0.1 to 0.3 mass % of Mg, 0.04 to 0.3 mass % of Si, and 0.1 to 0.5 mass % of Cu, and further containing 0.001 to 0.01 mass % of Ti and V in total, with the balance being Al and inevitable impurities.

In this embodiment, the reason why the content of Fe is set to 0.01 to 0.4 mass %, is to utilize various effects by mainly AI—Fe-based intermetallic compound. Fe is made into a solid solution in aluminum in an amount of only 0.05 mass % at 655° C., and is made into a solid solution lesser at room temperature. The remainder of Fe is crystallized or precipitated as intermetallic compounds, such as Al—Fe, Al—Fe—Si, Al—Fe—Si—Mg, and Al—Fe—Cu—Si. The crystallized or precipitated product acts as a refiner for grains to make the grain size fine, and enhances the mechanical strength and resistance to bending fatigue. On the other hand, the mechanical strength is enhanced also by the solid-solution of Fe. When the content of Fe is too small, these effects are insufficient, and when the content is too large, the aluminum conductor is poor in the wire-drawing property due to coarsening of the precipitated product, and the intended resistance to bending fatigue cannot be obtained. Furthermore, the conductor is in a supersaturated solid solution state and the electrical conductivity is also lowered. The content of Fe is preferably 0.15 to 0.3 mass %, more preferably 0.18 to 0.25 mass %.

In this embodiment, the reason why the content of Mg is set to 0.1 to 0.3 mass %, is to make Mg into a solid solution in the aluminum matrix, to strengthen the resultant alloy. Further, another reason is to make a part of Mg form a precipitate with Si, to make it possible to enhance mechanical strength and to improve resistance to bending fatigue and heat resistance. When the content of Mg is too small, those effects are insufficient, and when the content is too large, electrical conductivity is lowered. Furthermore, when the content of Mg is too large, the yield strength becomes excessive, the formability and twistability are deteriorated, and the workability becomes worse. The content of Mg is preferably 0.15 to 0.3 mass %, more preferably 0.2 to 0.28 mass %.

In this embodiment, the reason why the content of Si is set to 0.04 to 0.3 mass %, is to make Si form a compound (precipitate) with Mg, to act to enhance the mechanical strength, and to improve resistance to bending fatigue and heat resistance, as mentioned above. When the content of Si is too small, those effects become insufficient, and when the content is too large, the electrical conductivity is lowered. The content of Si is preferably 0.06 to 0.25 mass %, more preferably 0.10 to 0.25 mass %.

In this embodiment, the reason why the content of Cu is set to 0.1 to 0.5 mass %, is to make Cu into a solid solution in the aluminum matrix, to strengthen the resultant alloy. Furthermore, Cu also contributes to the improvement in creep resistance, resistance to bending fatigue, and heat resistance. When the content of Cu is too small, those effects become insufficient, and when the content is too large, lowering in corrosion resistance and electrical conductivity is caused. The content of Cu is preferably 0.20 to 0.45 mass %, more preferably 0.25 to 0.40 mass %.

In this embodiment, Ti and V each act as a refiner for grains of an ingot in melt-casting. If the microstructure of the ingot is coarse, cracks occur in the course of wire-drawing, which is not desirable from industrial viewpoints. When the content of Ti and V in total is too small, the effects are insufficient, and when the total content is too large, electrical conductivity is conspicuously lowered and the effects are also saturated. The content of Ti and V in total is preferably 0.002 to 0.008 mass %, more preferably 0.003 to 0.006 mass %.

A preferable second embodiment of the present invention has an alloy composition, which contains 0.4 to 1.5 mass % of Fe, with the balance being Al and inevitable impurities.

In the second embodiment, the reason why the content of Fe is set to 0.4 to 1.5 mass %, is to utilize various effects by the intermetallic compound, as mentioned in the first embodiment. When the content of Fe is too small, the tensile strength is low since Cu and Mg are not contained in the second embodiment; and, when the content is too large, the Al—Fe-based intermetallic compound inhibits the migration of the recrystallized grain boundary in the growth of the recrystallized grains, and thus the target recrystallized texture cannot be obtained and the resistance to bending fatigue becomes worse. The content of Fe is preferably 0.6 to 1.3 mass %, more preferably 0.8 to 1.1 mass %.

A preferable third embodiment of the present invention has an alloy composition, which contains 0.4 to 1.5 mass % of Fe, 0.1 to 0.3 mass % of Mg, 0.04 to 0.3 mass % of Si, with the balance being Al and inevitable impurities.

In the third embodiment, as compared with the alloy composition of the above first embodiment, the content of Fe is larger, and Cu is not contained. The reason why the content of Fe is set to 0.4 to 1.5 mass %, is to utilize various effects mainly by the Al—Fe-based intermetallic compound. The effects thereby are as mentioned in the first embodiment. When the content of Fe is too small, the tensile strength is low since Cu is not contained in the third embodiment; and, when the content is too large, the Al—Fe-based intermetallic compound inhibits the migration of the recrystallized grain boundary in the growth of the recrystallized grains, and thus the target recrystallized texture cannot be obtained and the resistance to bending fatigue becomes worse. Furthermore, the alloy is put into a supersaturated solid-solution state, and the electrical conductivity is also lowered. The content of Fe is preferably 0.6 to 1.3 mass %, more preferably 0.8 to 1.1 mass %.

Other alloy composition (i.e. alloying elements) and the effects thereof are similar to those in the above first embodiment.

A preferable fourth embodiment of the present invention is an aluminum alloy conductor having an alloy composition, containing: 0.01 to 0.5 mass % of Fe, 0.3 to 1.0 mass % of Mg, 0.3 to 1.0 mass % of Si, and 0.01 to 0.2 mass % of Cu, with the balance being Al and inevitable impurities.

In this embodiment, the reason why the content of Fe is set to 0.01 to 0.5 mass %, is to utilize various effects by the intermetallic compound, as mentioned in the first embodiment. This is because, when the content of Fe is too small, the effects are insufficient; and, when the content is too large, the wire-drawing property becomes worse due to the coarsening of the crystallized product, and thus the target resistance to bending fatigue cannot be obtained. The content of Fe is preferably 0.15 to 3.3 mass %, more preferably 0.18 to 0.25 mass %.

The reason why the content of Mg is set to 0.3 to 1.0 mass %, is to precipitate a large amount of an Mg—Si-based precipitated product, to thereby enhance the mechanical strength while maintaining the electrical conductivity suitably. When the content of Mg is too small, enhancement of the mechanical strength cannot be expected much; and, when the content is too large, the Mg—Si-based intermetallic compound inhibits the migration of the recrystallized grain boundary in the growth of the recrystallized grains, and thus the target recrystallized texture cannot be obtained. The content of Mg is preferably 0.4 to 0.9 mass %, more preferably 0.5 to 0.8 mass %.

The reason why the content of Si is set to 0.3 to 1.0 mass %, is, similar to those as mentioned above for Mg, to precipitate a large amount of the Mg—Si-based precipitated product, to thereby enhance the mechanical strength while maintaining the electrical conductivity suitably. When the content of Si is too small, enhancement of the mechanical strength cannot be expected much; and, when the content is too large, the Mg—Si-based intermetallic compound inhibits the migration of the recrystallized grain boundary in the growth of the recrystallized grains, and thus the target recrystallized texture cannot be obtained. Furthermore, an excess amount of the intermetallic compound causes wire breakage in wire drawing. The content of Si is preferably 0.4 to 0.9 mass %, more preferably 0.5 to 0.8 mass %.

The reason why the content of Cu is set to 0.01 to 0.2 mass %, is to make Cu into a solid solution in the aluminum matrix, to exhibit strengthening. When the content of Cu is too small, the effect is insufficient; and, when the content is too large, the electrical conductivity is further lowered since large amounts of Mg and Si are contained in this embodiment. The content of Cu is preferably 0.05 to 0.2 mass %, more preferably 0.1 to 0.2 mass %.

Since the aluminum alloy conductor of the present invention has high mechanical strength and electrical conductivity, it can be preferably used as a conductor wire for battery cables, harnesses, or motors, each of which are installed in or mounted on movable bodies. Examples of the movable bodies include automobiles, train vehicles, and aircraft. Since the aluminum alloy conductor of the present invention is excellent in resistance to bending fatigue, it can also be preferably used, for example, in doors, trunks, and hoods (or bonnets) of these movable bodies.

### EXAMPLES

The present invention will be described in more detail based on examples given below, but the invention is not meant to be limited by these.

### Examples 1 to 4, Comparative examples 1 to 4, and Conventional example 1 to 4

The wires of the respective Examples, Comparative examples, and Conventional examples were prepared as follows. The wires of Comparative example 1-No. 12, Comparative example 3-No. 8, and Comparative example 3-No. 9 were prepared by other methods, as mentioned below.

Fe, Mg, Si, Cu, Ti, V, and Al in the amounts (mass %), as shown in Tables 1 to 4, were made into the respective molten metals, followed by rolling, while continuously casting in a water-cooled casting mold, by using a Properzi-type continuous cast-rolling machine, to give respective rods with diameter about 10 mm. At that time, the cooling speed in casting was 1 to 20° C./sec.

Then, stripping off of the surface of the rods was conducted, to the diameter of about 9.5 mm, followed by wire drawing to attain a given working degree, respectively. Then, as shown in Tables 1 to 4, the thus-roughly-cold-drawn wires were subjected to intermediate annealing at a temperature of 300 to 450° C. for 0.5 to 4 hours, followed by wire drawing to a given diameter. The wire-drawing speed was set to 400 to 2,100 m/min.

The working history of the wire drawings and the working degree n before the continuous heat treatment are in the following relationships.

9.5 mmφ→0.55 mmφ→Intermediate annealing→0.37 mmφ(η=0.8)

9.5 mmφ→0.54 mmφ→Intermediate annealing→0.31 mmφ(η1=1.1)

9.5 mmφ→0.9 mmφ→Intermediate annealing→0.31 mmφ(η1=2.1)

9.5 mmφ→1.5 mmφ→Intermediate annealing→0.31 mmφ(η=3.2)

9.5 mmφ→2.6 mmφ→Intermediate annealing→0.43 mmφ(η=3.6) w9.5 mmφ→2.6 mmφ→Intermediate annealing→0.37 mmφ(η=3.9)

9.5 mmφ→2.6 mmφ→Intermediate annealing→0.31 mmφ(η=4.3)

9.5 mmφ→5.7 mmφ→Intermediate annealing→0.31 mmφ(η=5.8)

The wires that were tried to be drawn at a working degree of 6 or more, were broken at a wire diameter to give a working degree of 6.2 or 6.3 (respectively, at 0.43 mmφ or 0.40 mmφ).

Finally, as the finish annealing, a continuous electric heat treatment was conducted at a temperature of 421 to 605° C. for a time period of 0.03 to 0.54 seconds, or alternatively a continuous running heat treatment was conducted at a temperature of 326 to 586° C. for a time period of 1.5 to 5.0 seconds. The temperature was the wire temperature y (° C.) measured at immediately before passage into water (in the case of the continuous electric heat treatment) or the annealing furnace temperature z (° C.) (in the case of the continuous running heat treatment), at which the temperature of the wire would be the highest, with a fiber-type radiation thermometer (manufactured by Japan Sensor Corporation). Furthermore, as conventional examples, a batch-type heat treatment was conducted under conditions of a heat treatment furnace temperature of 350 to 450° C. and a time period of 3,600 seconds.

### Comparative Example 1-No. 12

As shown in Table 1 below, Fe, Cu, Mg, and Al were melted in a usual manner at a predetermined amount ratio (mass %), followed by being cast in a casting mold of 25.4 mm square, to give an ingot. The ingot was then kept at 400° C. for 1 hour, followed by hot rolling by grooved rolls, thereby to work into a roughly-drawn rod with rod diameter 9.5 mm.

The roughly-drawn rod was then subjected to wire drawing to wire diameter 0.9 mm, followed by heat treatment by maintaining at 350° C. for 2 hours, quenching, and further continuing wire drawing, thereby to prepare an aluminum alloy element wire with wire diameter 0.32 mm.

Finally, the thus-prepared aluminum alloy element wire with wire diameter 0.32 mm, was subjected to heat treatment by maintaining at 350° C. for 2 hours, followed by cooled slowly.

### Comparative Examples 3-No. 8

As shown in Table 3 below, Fe, Mg, Si, and Al were melted in a usual manner at a predetermined amount ratio (mass %), followed by working into a roughly-drawn rod with rod diameter 9.5 mm by continuous cast-rolling.

The roughly-drawn rod was then subjected to wire drawing to wire diameter 2.6 mm, followed by heat treatment by maintaining at 350° C. for 2 hours so that the tensile strength after the heat treatment would become 150 MPa or less, and further continuing wire drawing, thereby to prepare an aluminum alloy element wire with wire diameter 0.32 mm.

### Comparative Examples 3-No. 9

As shown in Table 3 below, Fe, Mg, Si, and Al were melted at a predetermined amount ratio (mass %) to give an alloy molten metal, followed by being cast in a continuous casting machine, to give a cast bar. Then, from the cast bar was, a wire rod of φ9.5 mm was prepared by a hot-rolling machine, and the thus-obtained wire rod was subjected to cold-wire drawing, thereby to prepare an electrical element wire of φ0.26 mm. Seven of the resultant electrical element wires were then twisted together, to form a twisted wire. Then, the resultant twisted wire was subjected to solution treatment, followed by cooling and aging heat treatment, to give an electrical wire conductor. At that time, the temperature in the solution treatment was 550° C., the annealing temperature in the aging heat treatment was 170° C., and the annealing time period was 12 hours. The twisted wire was unwound or untied, to take out one element wire, which was evaluated on the properties, as shown in Table 3.

With respect to the wires thus-prepared in Examples (Ex) according to the present invention, Comparative examples (Comp ex), and Conventional examples (Cony ex), the properties were measured according to the methods described below. The results are shown in Tables 1 to 4.

### (a) Grain Size (GS)

The transverse cross-section of the respective wire sample cut out vertically to the wire-drawing direction, was filled with a resin, followed by mechanical polishing and electrolytic polishing. The conditions of the electrolytic polishing were as follows: polish liquid, a 20% ethanol solution of perchloric acid; liquid temperature, 0 to 5° C.; voltage, 10 V; current, 10 mA; and time period, 30 to 60 seconds. Then, in order to obtain a contrast of grains, the resultant sample was subjected to anodizing finishing, with 2% hydrofluoroboric acid, under conditions of voltage 20 V, electrical current 20 mA, and time period 2 to 3 min. The resultant microstructure was observed to take a microscopic picture by an optical microscope with a magnification of 200× to 400× and photographed, and the grain size was measured by an intersection method. Specifically, a straight line was drawn arbitrarily on a microscopic picture taken, and the number of intersection points at which the length of the straight line intersected with the grain boundaries was measured, to determine an average grain size. The grain size was evaluated by changing the length and the number of straight lines so that 50 to 100 grains would be counted.

### (b) Area Ratios in Respective Crystal Orientations

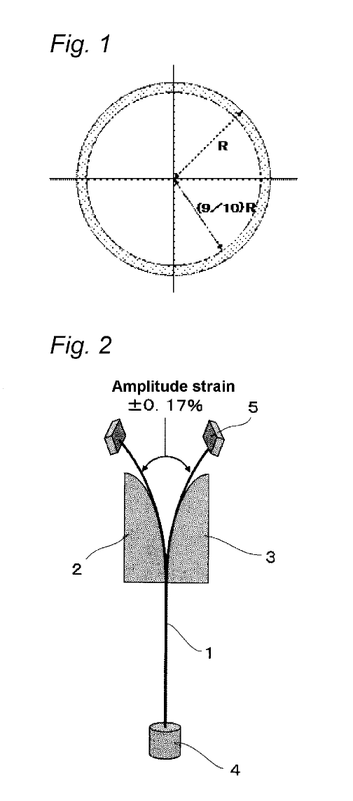

In the analysis of crystal orientations in the present invention, use was made of EBSD. The orientation analysis was conducted, mainly on an area of a sample with diameter 310 μm, on the cross-section of the wire vertical to the wire-drawing direction. The measured area and scan step were adjusted for every sample, the area to be measured was determined based on FIG. 1, and the scan step was set to about ⅕ to 1/10 of the average grain size of the sample. The area ratio in each orientation is the ratio of the area of the grains inclined in the wire-drawing direction within the range of ±10° from an ideal crystal plane, such as a (111) plane and a (112) plane, to the entirety of the measured area.

The value shown as “Entirety” in the tables is a measured value in the entirety of the area of the sample; and the value shown as “Surface layer” is a measured value in an area (see FIG. 1) formed by removing, from the entirety of the wire, a portion included in a circle with radius (9/10)R from the center of the wire on the cross-section of the wire vertical to the wire-drawing direction. (c) Tensile strength (TS) and flexibility (tensile elongation at breakage, EI)

Three test pieces for each sample were tested according to JIS Z 2241, and the average value was obtained, respectively. A tensile strength of 80 MPa or more was judged as passing the criterion. For flexibility, a tensile elongation at breakage of 10% or more was judged as passing the criterion.

### (d) Electrical Conductivity (EC)

Specific resistivity of three test pieces with length 300 mm for each sample was measured, by using a four-terminal method, in a thermostatic bath kept at 20° C. (±0.5° C.), to calculate the average electrical conductivity therefrom. The distance between the terminals was set to 200 mm. In Examples 1 and 3, an electrical conductivity of 55% IACS or more was judged to pass the criterion. In Example 2, 60% IACS or more was judged to pass the criterion. In Example 4, 45% IACS or more was judged to pass the criterion.

### (e) The Number of Repeating Times at Breakage

As a criterion for the resistance to bending fatigue, a strain amplitude at an ordinary temperature was set to ±0.17%. The resistance to bending fatigue varies depending on the strain amplitude. When the strain amplitude is large, the resultant fatigue life is short, while when small, the resultant fatigue life is long. Since the strain amplitude can be determined by the wire diameter of a wire 1 and the curvature radii of bending jigs 2 and 3 as shown in FIG. 2, a bending fatigue test can be conducted by arbitrarily setting the wire diameter of the wire 1 and the curvature radii of the bending jigs 2 and 3.

Using a reversed bending fatigue test machine manufactured by Fujii Seiki, Co. Ltd. (currently renamed to Fujii, Co. Ltd.), and using jigs that can impart a bending strain of 0.17% to the wire, the number of repeating times at breakage was measured, by conducting repeated bending. The number of repeating times at breakage was measured from 4 test pieces for each sample, and the average value thereof was obtained. As shown in the explanatory view of FIG. 2, the wire 1 was inserted between the bending jigs 2 and 3 that were spaced by 1 mm, and moved in a reciprocate manner along the jigs 2 and 3. One end of the wire was fixed on a holding jig 5 so that bending can be conducted repeatedly, and a weight 4 of about 10 g was hanged from the other end. Since the holding jig 5 moves in the test, the wire 1 fixed thereon also moves, thereby repeating bending can be conducted. The repeating was conducted under the condition of 100 times per 1 minute and the test machine has a mechanism in which the weight 4 falls to stop counting when the test piece of the wire 1 is broken.

In Example 1, 80,000 or more of the number of repeating times at breakage was judged to pass the criterion. In Example 2, 55,000 or more was judged to pass the criterion. In Example 3, 65,000 or more was judged to pass the criterion. In Example 4, 80,000 or more was judged to pass the criterion. Furthermore, in each example, the case where the of the number of repeating times at breakage was improved by 1.3 times or more (i.e. x1.3 or more), as compared to Conventional example, was judged to pass the criterion.

TABLE 1-1

| | | Composition (mass %) | | | | | |
|---|---|---|---|---|---|---|---|
| | No. | Fe | Mg | Si | Cu | Ti + V | Al |
| Ex 1 | 1 | 0.04 | 0.12 | 0.25 | 0.15 | 0.003 | Balance |
| | 2 | 0.15 | 0.29 | 0.20 | 0.42 | 0.004 | |
| | 3 | 0.20 | 0.15 | 0.13 | 0.20 | 0.009 | |
| | 4 | 0.39 | 0.25 | 0.10 | 0.11 | 0.005 | |
| | 5 | 0.08 | 0.18 | 0.18 | 0.49 | 0.008 | |
| | 6 | 0.12 | 0.24 | 0.30 | 0.25 | 0.004 | |
| | 7 | 0.25 | 0.20 | 0.06 | 0.37 | 0.003 | |
| | 8 | 0.32 | 0.11 | 0.22 | 0.30 | 0.006 | |
| | 9 | 0.05 | 0.23 | 0.20 | 0.23 | 0.004 | |
| | 10 | 0.12 | 0.23 | 0.12 | 0.36 | 0.003 | |
| | 11 | 0.22 | 0.11 | 0.18 | 0.13 | 0.004 | |
| | 12 | 0.35 | 0.15 | 0.24 | 0.31 | 0.004 | |
| Comp | 1 | 0.60 | 0.22 | 0.20 | 0.21 | 0.002 | Balance |
| ex 1 | 2 | 0.20 | 0.05 | 0.21 | 0.20 | 0.003 | |
| | 3 | 0.21 | 0.20 | 0.01 | 0.20 | 0.003 | |
| | 4 | 0.21 | 0.20 | 0.20 | 0.05 | 0.005 | |
| | 5 | 0.20 | 0.19 | 0.20 | 0.71 | 0.003 | |
| | 6 | 0.20 | 0.19 | 0.21 | 0.21 | 0.001 | |
| | 7 | 0.20 | 0.20 | 0.21 | 0.20 | 0.003 | |
| | 8 | 0.20 | 0.21 | 0.20 | 0.21 | 0.003 | |
| | 9 | 0.21 | 0.18 | 0.21 | 0.19 | 0.004 | |
| | 10 | 0.20 | 0.19 | 0.21 | 0.19 | 0.003 | |
| | 11 | 0.20 | 0.20 | 0.20 | 0.21 | 0.003 | |
| | 12 | 0.21 | 0.12 | — | 0.43 | — | |
| Conv | 1 | 0.21 | 0.20 | 0.20 | 0.21 | 0.002 | Balance |
| ex 1 | | | | | | | |

TABLE 1-2

| | | [6] Wire-drawing | | Final | | Heat treatment conditions | | | | | |
|---|---|---|---|---|---|---|---|---|---|---|---|
| | | Drawing | Working | wire | Heat | Temp | Time | | | | |
| | | speed | degree | diameter | treatment | y or z | x | | | | |
| | No. | m/min | (η) | mmφ | method | (° C.) | (s) | 26x^{-0.6} + 377 | 23.5x^{-0.6} + 423 | −50x + 550 | −36x + 650 |
| Ex 1 | 1 | 1,500 | 2.1 | 0.31 | C electric | 595 | 0.03 | 590 | 616 | — | — |
| | 2 | 1,500 | 4.3 | 0.31 | | 496 | 0.11 | 476 | 512 | — | — |
| | 3 | 1,000 | 3.2 | 0.31 | | 480 | 0.18 | 450 | 489 | — | — |
| | 4 | 1,500 | 5.8 | 0.31 | | 437 | 0.54 | 415 | 457 | — | — |
| | 5 | 500 | 1.1 | 0.31 | C running | 510 | 2.0 | — | — | 450 | 578 |
| | 6 | 1,000 | 5.8 | 0.31 | | 326 | 5.0 | — | — | 300 | 470 |
| | 7 | 1,000 | 2.1 | 0.31 | | 498 | 1.5 | — | — | 475 | 596 |
| | 8 | 1,500 | 4.3 | 0.31 | | 480 | 3.0 | — | — | 400 | 542 |
| | 9 | 1,500 | 3.6 | 0.43 | C electric | 602 | 0.03 | 590 | 616 | — | — |
| | 10 | 2,000 | 3.9 | 0.37 | | 485 | 0.11 | 476 | 512 | — | — |
| | 11 | 1,000 | 3.6 | 0.43 | | 481 | 0.18 | 450 | 489 | — | — |
| | 12 | 1,500 | 3.9 | 0.37 | | 434 | 0.54 | 415 | 457 | — | — |
| Comp | 1 | 1,000 | 3.2 | 0.31 | C electric | 492 | 0.11 | 476 | 512 | — | — |
| ex 1 | 2 | 1,500 | 4.3 | 0.31 | | 471 | 0.18 | 450 | 489 | — | — |
| | 3 | 1,500 | 2.1 | 0.31 | | 438 | 0.54 | 415 | 457 | — | — |
| | 4 | 1,500 | 2.1 | 0.31 | | 601 | 0.03 | 590 | 616 | — | — |
| | 5 | 1,000 | 4.3 | 0.31 | | 470 | 0.18 | 450 | 489 | — | — |
| | 6 | 400 | 4.3 | 0.31 | | 476 | 0.18 | 450 | 489 | — | — |
| | 7 | 2,100 | Wire breakage | | | | | | | | |
| | 8 | 1,500 | 0.8 | 0.37 | C electric | 490 | 0.11 | 476 | 512 | — | — |
| | 9 | 1,500 | 6.3 | Wire breakage | | | | | | | |
| | 10 | 1,500 | 5.8 | 0.31 | C electric | 452 | 0.11 | 476 | 512 | — | — |
| | 11 | 1,000 | 4.3 | 0.31 | | 534 | 0.11 | 476 | 512 | — | — |
| | 12 | Prepared by other production method *1 | | | | | | | | | |
| Conv | 1 | 1,000 | 3.2 | 0.31 | Batch- | 400 | 3,600 | — | — | — | — |
| ex 1 | | | | | type | | | | | | |

Note:
“C electric” means continuous electric heat treatment; “C running” means continuous running heat treatment; and “Batch-type” means batch-type heat treatment. The same will be applied to hereinafter.
*1 The wire was prepared according to the method reproducing Example 2 in JP-A-2006-253109. The details can be seen in the specification.

TABLE 1-3

| | | | | | | | | | The number of repeating | |
|---|---|---|---|---|---|---|---|---|---|---|
| | | Area ratio in respective | | | | | | | times at breakage | |
| | | crystal orientation (%) | | | | | | | | Comparison |
| | | Entirety | Surface layer | | GS | TS | EC | EI | | to Conv ex |
| | No. | (111) | (111) | (112) | (μm) | (MPa) | (% IACS) | (%) | (×10³) | x “X” |
| Ex 1 | 1 | 59 | 31 | 45 | 11.2 | 111 | 58.9 | 19.2 | 103 | 1.5 |
| | 2 | 56 | 33 | 38 | 12.4 | 139 | 56.3 | 15.0 | 128 | 1.8 |
| | 3 | 62 | 32 | 41 | 9.6 | 119 | 58.8 | 20.8 | 111 | 1.6 |
| | 4 | 45 | 28 | 35 | 7.5 | 125 | 59.0 | 21.7 | 96 | 1.4 |
| | 5 | 52 | 39 | 33 | 12.2 | 136 | 56.7 | 15.8 | 128 | 1.8 |
| | 6 | 64 | 34 | 39 | 14.2 | 127 | 56.5 | 15.7 | 127 | 1.8 |
| | 7 | 65 | 32 | 44 | 6.2 | 133 | 58.9 | 18.9 | 114 | 1.6 |
| | 8 | 48 | 27 | 26 | 8.8 | 134 | 57.6 | 18.9 | 111 | 1.6 |
| | 9 | 60 | 32 | 43 | 14.3 | 119 | 58.0 | 18.2 | 112 | 1.6 |
| | 10 | 54 | 35 | 29 | 10.1 | 129 | 58.3 | 17.1 | 114 | 1.6 |
| | 11 | 59 | 36 | 41 | 11.8 | 116 | 59.5 | 23.8 | 99 | 1.4 |
| | 12 | 57 | 34 | 34 | 8.9 | 138 | 57.2 | 17.3 | 118 | 1.7 |
| Comp | 1 | 15 | 15 | 16 | 6.8 | 144 | 57.4 | 15.9 | 72 | 1.0 |
| ex 1 | 2 | 21 | 23 | 18 | 12.3 | 114 | 59.4 | 21.7 | 63 | 0.9 |
| | 3 | 23 | 22 | 16 | 12.1 | 113 | 60.7 | 24.4 | 61 | 0.9 |
| | 4 | 24 | 15 | 17 | 10.6 | 108 | 58.9 | 22.2 | 65 | 0.9 |
| | 5 | 35 | 33 | 20 | 11.0 | 140 | 55.6 | 11.8 | 76 | 1.1 |
| | 6 | 32 | 19 | 23 | 12.1 | 124 | 58.5 | 16.4 | 74 | 1.1 |
| | 7 | | | | Wire breakage | | | | | |
| | 8 | 34 | 22 | 21 | 16.1 | 93 | 58.2 | 16.1 | 65 | 0.9 |
| | 9 | | | | Wire breakage | | | | | |
| | 10 | Not determined due to un- | | | | 178 | 58.3 | 2.3 | 122 | 1.7 |
| | | recrystallized | | | | | | | | |
| | 11 | 15 | 13 | 18 | 16.2 | 65 | 58.2 | 4.5 | 52 | 0.7 |
| | 12 | 32 | 15 | 16 | 12.0 | 132 | 58.6 | 20.3 | 78 | 1.1 |
| Conv | 1 | 19 | 22 | 19 | 11.5 | 119 | 58.4 | 18.0 | 70 | 1.0 |
| ex 1 | | | | | | | | | | |

With the aluminum alloy compositions of Comparative example 1-Nos. 1 to 5, the recrystallized texture as defined in the present invention was not obtained. Thus, the property to breakage by repeated bending was poor in each of Comparative example 1-Nos. 1 to 5. Comparative example 1-Nos. 6 to 12 were comparative examples each in which the aluminum alloy conductor as defined in the present invention was not obtained due to the production conditions of the aluminum alloy. In Comparative example 1-No. 6, the property to breakage by repeated bending was poor. In Comparative example 1-No. 7, the wire was broken in the wire drawing. In Comparative example 1-No. 8, the property to breakage by repeated bending was poor. In Comparative example 1-No. 9, the wire was broken in the wire drawing. In Comparative example 1-No. 10, the flexibility was poor since the wire was in an unannealed state. In Comparative example 1-No. 11, the property to breakage by repeated bending, tensile strength, and flexibility were poor. Comparative example 1-No. 12 was a reproduction of Example 2 of JP-A-2006-253109, and the property to breakage by repeated bending was poor. Conventional example 1-No. 1 was prepared by a conventional production method, and the property to breakage by repeated bending was poor. Contrary to those, in Example 1-Nos. 1 to 12 according to the present invention, aluminum alloy conductors were obtained, which were excellent in the property to breakage by repeated bending (resistance to bending fatigue), tensile strength, flexibility, and electrical conductivity.

TABLE 2-1

Composition
(mass %)

| | No. | Fe | Al |
|---|---|---|---|
| Ex 2 | 1 | 0.42 | Balance |
| | 2 | 0.61 | |
| | 3 | 1.01 | |
| | 4 | 0.61 | |
| | 5 | 0.90 | |
| | 6 | 1.19 | |
| | 7 | 1.50 | |
| Comp | 1 | 0.18 | Balance |
| ex 2 | 2 | 1.80 | |
| Conv | 1 | 0.61 | Balance |
| ex 2 | | | |

TABLE 2-2

| | | [6] Wire-drawing | | Final | | Heat treatment conditions | | | | | |
|---|---|---|---|---|---|---|---|---|---|---|---|
| | | Drawing | Working | wire | Heat | Temp | Time | | | | |
| | | speed | degree | diameter | treatment | y or z | x | | | | |
| | No. | m/min | (η) | mmφ | method | (° C.) | (s) | 26x^{-0.6} + 377 | 23.5x^{-0.6} + 423 | −50x + 550 | −36x + 650 |
| Ex 2 | 1 | 1,500 | 5.8 | 0.31 | C electric | 600 | 0.03 | 590 | 616 | — | — |
| | 2 | 1,500 | 3.6 | 0.43 | | 483 | 0.11 | 476 | 512 | — | — |
| | 3 | 1,000 | 2.1 | 0.31 | | 482 | 0.18 | 450 | 489 | — | — |
| | 4 | 1,500 | 1.1 | 0.31 | C running | 560 | 2.0 | — | — | 450 | 578 |
| | 5 | 1,000 | 3.2 | 0.31 | | 457 | 2.0 | — | — | 450 | 578 |
| | 6 | 1,500 | 4.3 | 0.31 | | 412 | 4.0 | — | — | 350 | 506 |
| | 7 | 1,000 | 4.3 | 0.31 | | 475 | 0.18 | 450 | 489 | — | — |
| Comp | 1 | 1,500 | 4.3 | 0.31 | C electric | 470 | 0.18 | 450 | 489 | — | — |
| ex 2 | 2 | 1,500 | 5.8 | 0.31 | | 469 | 0.18 | 450 | 489 | — | — |
| Conv | 1 | 1,000 | 3.2 | 0.31 | Batch- | 450 | 3,600 | — | — | — | — |
| ex 2 | | | | | type | | | | | | |

TABLE 2-3

| | | | | | | | | | The number of repeating | |
|---|---|---|---|---|---|---|---|---|---|---|
| | | Area ratio in respective | | | | | | | times at breakage | |
| | | crystal orientation (%) | | | | | | | | Comparison |
| | | Entirety | Surface layer | | GS | TS | EC | EI | | to Conv ex |
| | No. | (111) | (111) | (112) | (μm) | (MPa) | (% IACS) | (%) | (×10³) | x “X” |
| Ex 2 | 1 | 40 | 27 | 38 | 11.2 | 87 | 63.1 | 41.8 | 63 | 1.5 |
| | 2 | 48 | 34 | 31 | 7.5 | 95 | 62.8 | 37.7 | 70 | 1.6 |
| | 3 | 54 | 38 | 27 | 7.8 | 104 | 60.7 | 34.5 | 59 | 1.4 |
| | 4 | 52 | 34 | 25 | 12.5 | 92 | 62.9 | 38.0 | 61 | 1.4 |
| | 5 | 55 | 33 | 33 | 5.3 | 96 | 61.9 | 34.1 | 72 | 1.7 |
| | 6 | 45 | 33 | 35 | 4.2 | 106 | 60.5 | 33.2 | 64 | 1.5 |
| | 7 | 45 | 33 | 32 | 2.3 | 114 | 60.2 | 30.3 | 58 | 1.3 |
| Comp | 1 | 32 | 22 | 23 | 20.3 | 73 | 63.2 | 42.0 | 40 | 0.9 |
| ex 2 | 2 | 11 | 13 | 19 | 3.3 | 130 | 57.5 | 21.1 | 38 | 0.9 |
| Conv | 1 | 15 | 12 | 18 | 8.6 | 92 | 62.7 | 36.3 | 43 | 1.0 |
| ex 2 | | | | | | | | | | |

With the aluminum alloy compositions of Comparative example 2-Nos. 1 to 2, the recrystallized texture as defined in the present invention was not obtained. The property to breakage by repeated bending was poor in each of Comparative example 2-Nos. 1 and 2, and further the tensile strength was poor in Comparative example 2-No. 1. Conventional example 2-No. 1 was prepared by a conventional production method, and the property to breakage by repeated bending was poor. Contrary to those, in Example 2-Nos. 1 to 7 according to the present invention, aluminum alloy conductors were obtained, which were excellent in the property to breakage by repeated bending (resistance to bending fatigue), tensile strength, flexibility, and electrical conductivity.

TABLE 3-1

Composition (mass %)

| | No. | Fe | Mg | Si | Al |
|---|---|---|---|---|---|
| Ex 3 | 1 | 0.41 | 0.18 | 0.11 | Balance |
| | 2 | 0.65 | 0.21 | 0.20 | |
| | 3 | 0.98 | 0.28 | 0.18 | |
| | 4 | 1.35 | 0.15 | 0.24 | |
| | 5 | 0.45 | 0.12 | 0.04 | |
| | 6 | 0.80 | 0.10 | 0.29 | |
| | 7 | 1.02 | 0.22 | 0.08 | |
| | 8 | 1.48 | 0.24 | 0.15 | |
| Comp | 1 | 2.00 | 0.20 | 0.20 | Balance |
| ex 3 | 2 | 0.80 | 0.60 | 0.20 | |
| | 3 | 0.80 | 0.21 | 0.61 | |
| | 4 | 0.80 | 0.22 | 0.20 | |
| | 5 | 0.80 | 0.21 | 0.21 | |
| | 6 | 0.80 | 0.20 | 0.20 | |
| | 7 | 0.80 | 0.21 | 0.20 | |
| | 8 | 1.20 | 0.23 | 0.03 | |
| | 9 | 0.10 | 0.50 | 0.30 | |
| Conv | 1 | 1.02 | 0.15 | 0.22 | Balance |
| ex 3 | | | | | |

TABLE 3-2

| | | [6] Wire-drawing | | Final | | Heat treatment conditions | | | | | |
|---|---|---|---|---|---|---|---|---|---|---|---|
| | | Drawing | Working | wire | Heat | Temp | Time | | | | |
| | | speed | degree | diameter | treatment | y or z | x | | | | |
| | No. | m/min | (η) | mmφ | method | (° C.) | (s) | 26x^{-0.6} + 377 | 23.5x^{-0.6} + 423 | −50x + 550 | −36x + 650 |
| Ex 3 | 1 | 2,000 | 3.2 | 0.31 | C electric | 603 | 0.03 | 590 | 616 | — | — |
| | 2 | 1,500 | 2.1 | 0.31 | | 496 | 0.11 | 476 | 512 | — | — |
| | 3 | 1,000 | 5.8 | 0.31 | | 481 | 0.18 | 450 | 489 | — | — |
| | 4 | 1,000 | 3.9 | 0.37 | | 421 | 0.54 | 415 | 457 | — | — |
| | 5 | 1,000 | 3.9 | 0.37 | C running | 558 | 2.0 | — | — | 450 | 578 |
| | 6 | 1,500 | 3.2 | 0.31 | | 377 | 4.0 | — | — | 350 | 506 |
| | 7 | 1,000 | 2.1 | 0.31 | | 525 | 2.0 | — | — | 450 | 578 |
| | 8 | 1,500 | 1.1 | 0.31 | | 434 | 4.0 | — | — | 350 | 506 |
| Comp | 1 | 1,500 | Wire breakage | | | | | | | | |
| ex 3 | 2 | 1,500 | 4.3 | 0.31 | C electric | 467 | 0.18 | 450 | 489 | — | — |
| | 3 | 1,000 | 1.1 | 0.31 | | 495 | 0.11 | 476 | 512 | — | — |
| | 4 | 1,500 | 3.2 | 0.31 | C running | 433 | 2.0 | — | — | 450 | 578 |
| | 5 | 1,500 | 4.3 | 0.31 | | 586 | 2.0 | — | — | 450 | 578 |
| | 6 | 1,000 | 0.8 | 0.31 | | 470 | 0.18 | 450 | 489 | — | — |
| | 7 | 1,000 | 6.2 | Wire breakage | | | | | | | |
| | 8 | Prepared by other production method *2 | | | | | | | | | |
| | 9 | Prepared by other production method *3 | | | | | | | | | |
| Conv | 1 | 1,000 | 4.3 | 0.31 | Batch- | 350 | 3,600 | — | — | — | — |
| ex 3 | | | | | type | | | | | | |

Note:
*2 The wire was prepared according to the method reproducing Example 6 in JP-A-2006-19163. The details can be seen in the specification.
*3 The wire was prepared according to the method reproducing Example 3 in JP-A-2008-112620. The details can be seen in the specification.

TABLE 3-3

| | | | | | | | | | The number of repeating | |
|---|---|---|---|---|---|---|---|---|---|---|
| | | Area ratio in respective | | | | | | | times at breakage | |
| | | crystal orientation (%) | | | | | | | | Comparison |
| | | Entirety | Surface layer | | GS | TS | EC | EI | | to Conv ex |
| | No. | (111) | (111) | (112) | (μm) | (MPa) | (% IACS) | (%) | (×10³) | x “X” |
| Ex 3 | 1 | 65 | 39 | 28 | 11.6 | 111 | 60.7 | 21.0 | 71 | 1.5 |
| | 2 | 56 | 32 | 37 | 7.1 | 123 | 58.7 | 19.2 | 77 | 1.6 |
| | 3 | 65 | 37 | 33 | 5.6 | 137 | 57.2 | 18.8 | 75 | 1.6 |
| | 4 | 53 | 31 | 42 | 2.4 | 148 | 57.3 | 19.3 | 74 | 1.6 |
| | 5 | 45 | 28 | 44 | 13.6 | 109 | 62.1 | 24.5 | 67 | 1.4 |
| | 6 | 57 | 28 | 37 | 5.7 | 128 | 58.0 | 19.0 | 71 | 1.5 |
| | 7 | 55 | 35 | 27 | 4.5 | 134 | 59.6 | 20.4 | 70 | 1.5 |
| | 8 | 59 | 34 | 35 | 2.8 | 153 | 57.8 | 19.3 | 73 | 1.6 |
| Comp | 1 | Wire breakage | | | | | | | | |
| ex 3 | 2 | 13 | 12 | 16 | 5.5 | 136 | 55.4 | 15.2 | 56 | 1.2 |
| | 3 | 13 | 12 | 16 | 5.7 | 147 | 53.7 | 14.4 | 52 | 1.1 |
| | 4 | Not determined due to un-recrystallized | | | | 172 | 57.0 | 5.5 | 72 | 1.5 |
| | 5 | 13 | 16 | 17 | 8.1 | 75 | 57.1 | 4.2 | 44 | 0.9 |
| | 6 | 33 | 21 | 19 | 8.8 | 120 | 57.0 | 5.8 | 51 | 1.1 |
| | 7 | Wire breakage | | | | | | | | |
| | 8 | 35 | 17 | 15 | Un-recrystallized | 270 | 58.2 | 1.0 | 229 | 4.9 |
| | 9 | 36 | 18 | 17 | Un-recrystallized | 248 | 54.6 | 5.8 | 136 | 2.9 |
| Conv | 1 | 15 | 16 | 17 | 4.8 | 136 | 58.2 | 19.0 | 47 | 1.0 |
| ex 3 | | | | | | | | | | |

With the aluminum alloy compositions of Comparative example 3-Nos. 1 to 3, the recrystallized texture as defined in the present invention was not obtained. In Comparative example 3-No. 1, the wire was broken in the wire drawing. In Comparative example 3-No. 2, the property to breakage by repeated bending was poor. In Comparative example 3-No. 3, the property to breakage by repeated bending, and electrical conductivity were poor. Comparative example 3-Nos. 4 to 9 were comparative examples each in which the aluminum alloy conductor as defined in the present invention was not obtained due to the production conditions of the aluminum alloy. In Comparative example 3-No. 4, the flexibility was poor since the wire was in an unrecrystallized state (a state in which annealing was insufficient). In Comparative example 3-No. 5, the property to breakage by repeated bending, tensile strength, and flexibility were poor. In Comparative example 3-No. 6, the property to breakage by repeated bending was poor. In Comparative example 3-No. 7, the wire was broken in the wire drawing. Comparative example 3-No. 8 was a reproduction of Example 6 of JP-A-2006-19163, and the flexibility was poor. Comparative example 3-No. 9 was a reproduction of Example 3 of JP-A-2008-112620, and the electrical conductivity and flexibility were poor. Conventional example 3-No. 1 was prepared by a conventional production method, and the property to breakage by repeated bending was poor. Contrary to those, in Example 3-Nos. 1 to 8 according to the present invention, aluminum alloy conductors were obtained, which were excellent in the property to breakage by repeated bending (resistance to bending fatigue), tensile strength, flexibility, and electrical conductivity.

TABLE 4-1

Composition (mass %)

| | No. | Fe | Mg | Si | Cu | Al |
|---|---|---|---|---|---|---|
| Ex 4 | 1 | 0.06 | 0.66 | 0.99 | 0.10 | Balance |
| | 2 | 0.11 | 0.35 | 0.68 | 0.05 | |
| | 3 | 0.21 | 0.41 | 0.33 | 0.19 | |
| | 4 | 0.30 | 0.78 | 0.77 | 0.08 | |
| | 5 | 0.39 | 0.52 | 0.55 | 0.07 | |
| | 6 | 0.49 | 0.86 | 0.31 | 0.13 | |
| | 7 | 0.03 | 0.98 | 0.48 | 0.03 | |
| | 8 | 0.12 | 0.60 | 0.94 | 0.15 | |
| | 9 | 0.21 | 0.95 | 0.43 | 0.11 | |
| | 10 | 0.32 | 0.31 | 0.89 | 0.08 | |
| | 11 | 0.36 | 0.46 | 0.60 | 0.05 | |
| | 12 | 0.47 | 0.73 | 0.38 | 0.18 | |
| Comp | 1 | 0.15 | 1.20 | 0.50 | 0.11 | Balance |
| ex 4 | 2 | 0.15 | 0.60 | 1.20 | 0.10 | |
| | 3 | 0.15 | 0.45 | 0.43 | 0.10 | |
| | 4 | 0.15 | 0.45 | 0.43 | 0.10 | |
| | 5 | 0.15 | 0.45 | 0.43 | 0.10 | |
| | 6 | 0.15 | 0.45 | 0.43 | 0.10 | |
| Conv | 1 | 0.30 | 0.45 | 0.50 | 0.08 | Balance |
| ex 4 | | | | | | |

TABLE 4-2

| | | [6] Wire-drawing | | Final | | Heat treatment conditions | | | | | |
|---|---|---|---|---|---|---|---|---|---|---|---|
| | | Drawing | Working | wire | Heat | Temp | Time | | | | |
| | | speed | degree | diameter | treatment | y or z | x | | | | |
| | No. | m/min | (η) | mmφ | method | (° C.) | (s) | 26x^{-0.6} + 377 | 23.5x^{-0.6} + 423 | −50x + 550 | −36x + 650 |
| Ex 4 | 1 | 1,000 | 4.3 | 0.31 | C electric | 595 | 0.03 | 590 | 616 | — | — |
| | 2 | 1,500 | 3.6 | 0.43 | | 471 | 0.18 | 450 | 489 | — | — |
| | 3 | 1,500 | 5.8 | 0.31 | | 447 | 0.54 | 415 | 457 | — | — |
| | 4 | 1,000 | 3.9 | 0.37 | | 601 | 0.03 | 590 | 616 | — | — |
| | 5 | 1,500 | 1.1 | 0.31 | | 496 | 0.11 | 476 | 512 | — | — |
| | 6 | 1,500 | 2.1 | 0.31 | | 472 | 0.18 | 450 | 489 | — | — |
| | 7 | 1,000 | 3.2 | 0.31 | C running | 510 | 2.0 | — | — | 450 | 578 |
| | 8 | 1,500 | 5.8 | 0.31 | | 508 | 2.0 | — | — | 450 | 578 |
| | 9 | 1,500 | 2.1 | 0.31 | | 582 | 1.5 | — | — | 475 | 596 |
| | 10 | 1,000 | 1.1 | 0.31 | | 433 | 4.0 | — | — | 350 | 506 |
| | 11 | 1,500 | 3.9 | 0.37 | | 336 | 5.0 | — | — | 300 | 470 |
| | 12 | 1,000 | 4.3 | 0.31 | | 492 | 3.0 | — | — | 400 | 542 |
| Comp | 1 | 1,000 | 3.2 | 0.31 | C electric | 605 | 0.03 | 590 | 616 | — | — |
| ex 4 | 2 | 1,000 | 1.1 | 0.31 | | 497 | 0.11 | 476 | 512 | — | — |
| | 3 | 1,000 | 0.8 | 0.31 | C electric | 470 | 0.18 | 450 | 489 | — | — |
| | 4 | 1,000 | 6.2 | Wire breakage | | | | | | | |
| | 5 | 400 | 4.3 | 0.31 | C electric | 471 | 0.18 | 450 | 489 | — | — |
| | 6 | 2,100 | Wire breakage | | | | | | | | |
| Conv | 1 | 1,000 | 3.2 | 0.31 | Batch- | 400 | 3,600 | — | — | — | — |
| ex 4 | | | | | type | | | | | | |

TABLE 4-3

| | | | | | | | | | The number of repeating | |
|---|---|---|---|---|---|---|---|---|---|---|
| | | Area ratio in respective | | | | | | | times at breakage | |
| | | crystal orientation (%) | | | | | | | | Comparison |
| | | Entirety | Surface layer | | GS | TS | EC | EI | | to Conv ex |
| | No. | (111) | (111) | (112) | (μm) | (MPa) | (% IACS) | (%) | (×10³) | x “X” |
| Ex 4 | 1 | 48 | 35 | 35 | 14.3 | 147 | 48.0 | 11.2 | 86 | 1.5 |
| | 2 | 48 | 35 | 32 | 12.5 | 127 | 52.5 | 14.8 | 85 | 1.5 |
| | 3 | 52 | 32 | 42 | 12.3 | 133 | 54.5 | 16.3 | 105 | 1.8 |
| | 4 | 44 | 29 | 36 | 8.6 | 154 | 48.7 | 11.6 | 85 | 1.5 |
| | 5 | 50 | 37 | 33 | 6.8 | 144 | 52.1 | 14.3 | 103 | 1.8 |
| | 6 | 42 | 32 | 35 | 6.1 | 156 | 51.9 | 13.2 | 87 | 1.5 |
| | 7 | 48 | 39 | 28 | 15.8 | 134 | 50.4 | 12.2 | 83 | 1.4 |
| | 8 | 45 | 28 | 32 | 10.3 | 150 | 48.2 | 11.4 | 98 | 1.7 |
| | 9 | 52 | 34 | 29 | 12.1 | 147 | 51.0 | 12.2 | 91 | 1.6 |
| | 10 | 41 | 25 | 41 | 7.7 | 145 | 50.5 | 13.3 | 82 | 1.4 |
| | 11 | 55 | 38 | 26 | 5.7 | 140 | 52.0 | 14.5 | 91 | 1.6 |
| | 12 | 48 | 33 | 35 | 6.3 | 156 | 51.8 | 13.3 | 111 | 1.9 |
| Comp | 1 | 12 | 13 | 18 | 9.5 | 148 | 48.8 | 9.5 | 59 | 1.0 |
| ex 4 | 2 | 12 | 14 | 17 | 9.8 | 151 | 46.3 | 9.2 | 58 | 1.0 |
| | 3 | 29 | 18 | 17 | 11.2 | 131 | 52.1 | 11.5 | 56 | 1.0 |
| | 4 | Wire breakage | | | | | | | | |
| | 5 | 33 | 19 | 22 | 10.5 | 138 | 52.0 | 11.8 | 58 | 1.0 |
| | 6 | Wire breakage | | | | | | | | |
| Conv | 1 | 13 | 14 | 17 | 8.6 | 136 | 53.3 | 12.3 | 58 | 1.0 |
| ex 4 | | | | | | | | | | |

With the aluminum alloy compositions of Comparative example 4-Nos. 1 to 2, the recrystallized texture as defined in the present invention was not obtained. In each of Comparative example 4-Nos. 1 and 2, the property to breakage by repeated bending, and flexibility were poor. Comparative example 4-Nos. 3 to 6 were comparative examples each in which the aluminum alloy conductor as defined in the present invention was not obtained due to the production conditions of the aluminum alloy. In Comparative example 4-No. 3, the property to breakage by repeated bending was poor. In Comparative example 4-No. 4, the wire was broken in the wire drawing. In Comparative example 4-No. 5, the property to breakage by repeated bending was poor. In Comparative example 4-No. 6, the wire was broken in the wire drawing. Conventional example 4-No. 1 was prepared by a conventional production method, and the property to breakage by repeated bending was poor. Contrary to those, in Example 4-Nos. 1 to 12 according to the present invention, aluminum alloy conductors were obtained, which were excellent in the property to breakage by repeated bending (resistance to bending fatigue), tensile strength, flexibility, and electrical conductivity.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. §119 (a) on Patent Application No. 2010-161116 filed in Japan on Jul. 15, 2010, which is entirely herein incorporated by reference.

### REFERENCE SIGNS LIST

1 Test piece (wire)
2, 3 Bending jig
4 Weight
5, 51, 52 Holding jig

1. An aluminum alloy conductor, which has a composition consisting of: 0.01 to 0.4 mass % of Fe, 0.1 to 0.3 mass % of Mg, 0.04 to 0.3 mass % of Si, 0.1 to 0.5 mass % of Cu, and 0.001 to 0.01 mass % of Ti and V in total, with the balance being Al and inevitable impurities,
which has a recrystallized texture of 40% or more of an area ratio of grains each having a (111) plane and being positioned in parallel to a cross-section vertical to a wire-drawing direction of a wire, and
which has a grain size of 1 to 30 μm on the cross-section vertical to the wire-drawing direction of the wire.

2. The aluminum alloy conductor according to claim 1, which has the recrystallized texture of 25% or more of the area ratio of grains each having a (111) plane and being positioned in parallel to the cross-section vertical to the wire-drawing direction of the wire, and of 25% or more of an area ratio of grains each having a (112) plane and being positioned in parallel to the cross-section vertical to the wire-drawing direction of the wire, in an area formed by removing, from the entirety of the wire, a portion included in a circle with a radius of (9/10)R from the center of the wire on the cross-section vertical to the wire-drawing direction of the wire, in which R is a radius of the wire.

3. A method of producing an aluminum alloy conductor, comprising:
subjecting an aluminum alloy material which has a composition consisting of: 0.01 to 0.4 mass % of Fe, 0.1 to 0.3 mass % of Mg, 0.04 to 0.3 mass % of Si, 0.1 to 0.5 mass % of Cu, and 0.001 to 0.01 mass % of Ti and V in total, with the balance being Al and inevitable impurities, to the steps comprising:
[1] melting;
[2] casting with a cooling speed of 1 to 20° C./sec;
[3] hot- or cold-working;
[4] wire drawing with a working degree from 1 to 6;
[5] intermediate annealing at 300 to 450° C., for 10 min or more;
[6] wire drawing with a working degree from 1 to 6; and
[7] finish annealing,
wherein the finish annealing [7] is conducted by a continuous running heat treatment that is a continuous heat treatment comprising the steps of: rapid heating, and quenching, in which an annealing furnace temperature z (° C.) and an annealing time period x (sec) satisfy relationships of:
1.5≦x≦5, and
−50x+550≦z≦−36x+650, and
wherein the thus-produced aluminum alloy conductor has a recrystallized texture of 40% or more of an area ratio of grains each having a (111) plane and being positioned in parallel to a cross-section vertical to a wire-drawing direction of a wire, and has a grain size of 1 to 30 μm on the cross-section vertical to the wire-drawing direction of the wire.

4. The method of producing according to claim 3, wherein the thus-produced aluminum alloy conductor has the recrystallized texture of 25% or more of the area ratio of grains each having a (111) plane and being positioned in parallel to the cross-section vertical to the wire-drawing direction of the wire, and of 25% or more of an area ratio of grains each having a (112) plane and being positioned in parallel to the cross-section vertical to the wire-drawing direction of the wire, in an area formed by removing, from the entirety of the wire, a portion included in a circle with a radius of (9/10)R from the center of the wire on the cross-section vertical to the wire-drawing direction of the wire, in which R is a radius of the wire.

5. The method of producing according to claim 3, wherein the wire drawing [6] is conducted at a wire-drawing speed of 500 to 2,000 m/min.

6. An aluminum alloy conductor, which has a composition consisting of: 0.4 to 1.5 mass % of Fe, with the balance being Al and inevitable impurities, which has a recrystallized texture of 40% or more of an area ratio of grains each having a (111) plane and being positioned in parallel to a cross-section vertical to a wire-drawing direction of a wire, and
which has a grain size of 1 to 30 μm on the cross-section vertical to the wire-drawing direction of the wire.

7. The aluminum alloy conductor according to claim 6, which has the recrystallized texture of 25% or more of the area ratio of grains each having a (111) plane and being positioned in parallel to the cross-section vertical to the wire-drawing direction of the wire, and of 25% or more of an area ratio of grains each having a (112) plane and being positioned in parallel to the cross-section vertical to the wire-drawing direction of the wire, in an area formed by removing, from the entirety of the wire, a portion included in a circle with a radius of (9/10)R from the center of the wire on the cross-section vertical to the wire-drawing direction of the wire, in which R is a radius of the wire.

8. A method of producing an aluminum alloy conductor, comprising:
subjecting an aluminum alloy material which has a composition consisting of: 0.4 to 1.5 mass % of Fe, with the balance being Al and inevitable impurities, to the steps comprising:
[1] melting; [2] casting with a cooling speed of 1 to 20° C./sec;
[3] hot- or cold-working;
[4] wire drawing with a working degree from 1 to 6;
[5] intermediate annealing at 300 to 450° C., for 10 min or more;
[6] wire drawing with a working degree from 1 to 6; and
[7] finish annealing,
wherein the finish annealing [7] is conducted by a continuous running heat treatment that is a continuous heat treatment comprising the steps of: rapid heating, and quenching, in which an annealing furnace temperature z (° C.) and an annealing time period x (sec) satisfy relationships of:
1.5≦x≦5, and
−50x+550≦z≦−36x+650, and
wherein the thus-produced aluminum alloy conductor has a recrystallized texture of 40% or more of an area ratio of grains each having a (111) plane and being positioned in parallel to a cross-section vertical to a wire-drawing direction of a wire, and has a grain size of 1 to 30 μm on the cross-section vertical to the wire-drawing direction of the wire.

9. The method of producing according to claim 8, wherein the thus-produced aluminum alloy conductor has the recrystallized texture of 25% or more of the area ratio of grains each having a (111) plane and being positioned in parallel to the cross-section vertical to the wire-drawing direction of the wire, and of 25% or more of an area ratio of grains each having a (112) plane and being positioned in parallel to the cross-section vertical to the wire-drawing direction of the wire, in an area formed by removing, from the entirety of the wire, a portion included in a circle with a radius of (9/10)R from the center of the wire on the cross-section vertical to the wire-drawing direction of the wire, in which R is a radius of the wire.

10. The method of producing according to claim 8, wherein the wire drawing [6] is conducted at a wire-drawing speed of 500 to 2,000 m/min.

11. An aluminum alloy conductor, which has a composition consisting of: 0.4 to 1.5 mass % of Fe, 0.1 to 0.3 mass % of Mg, and 0.04 to 0.3 mass % of Si, with the balance being Al and inevitable impurities,
which has a recrystallized texture of 40% or more of an area ratio of grains each having a (111) plane and being positioned in parallel to a cross-section vertical to a wire-drawing direction of a wire, and
which has a grain size of 1 to 30 μm on the cross-section vertical to the wire-drawing direction of the wire.

12. The aluminum alloy conductor according to claim 11, which has the recrystallized texture of 25% or more of the area ratio of grains each having a (111) plane and being positioned in parallel to the cross-section vertical to the wire-drawing direction of the wire, and of 25% or more of an area ratio of grains each having a (112) plane and being positioned in parallel to the cross-section vertical to the wire-drawing direction of the wire, in an area formed by removing, from the entirety of the wire, a portion included in a circle with a radius of (9/10)R from the center of the wire on the cross-section vertical to the wire-drawing direction of the wire, in which R is a radius of the wire.

13. A method of producing an aluminum alloy conductor, comprising:
subjecting an aluminum alloy material which has a composition consisting of: 0.4 to 1.5 mass % of Fe, 0.1 to 0.3 mass % of Mg, and 0.04 to 0.3 mass % of Si, with the balance being Al and inevitable impurities, to the steps comprising:
[1] melting;
[2] casting with a cooling speed of 1 to 20° C./sec;
[3] hot- or cold-working;
[4] wire drawing with a working degree from 1 to 6;
[5] intermediate annealing at 300 to 450° C., for 10 min or more;
[6] wire drawing with a working degree from 1 to 6; and
[7] finish annealing,
wherein the finish annealing [7] is conducted by a continuous running heat treatment that is a continuous heat treatment comprising the steps of: rapid heating, and quenching, in which an annealing furnace temperature z (° C.) and an annealing time period x (sec) satisfy relationships of:
1.5≦x≦5, and
−50x+550≦z≦−36x+650, and
wherein the thus-produced aluminum alloy conductor has a recrystallized texture of 40% or more of an area ratio of grains each having a (111) plane and being positioned in parallel to a cross-section vertical to a wire-drawing direction of a wire, and has a grain size of 1 to 30 μm on the cross-section vertical to the wire-drawing direction of the wire.

14. The method of producing according to claim 13, wherein the thus-produced aluminum alloy conductor has the recrystallized texture of 25% or more of the area ratio of grains each having a (111) plane and being positioned in parallel to the cross-section vertical to the wire-drawing direction of the wire, and of 25% or more of an area ratio of grains each having a (112) plane and being positioned in parallel to the cross-section vertical to the wire-drawing direction of the wire, in an area formed by removing, from the entirety of the wire, a portion included in a circle with a radius of (9/10)R from the center of the wire on the cross-section vertical to the wire-drawing direction of the wire, in which R is a radius of the wire.

15. The method of producing according to claim 13, wherein the wire drawing [6] is conducted at a wire-drawing speed of 500 to 2,000 m/min.

16. An aluminum alloy conductor, which has a composition consisting of: 0.01 to 0.5 mass % of Fe, 0.3 to 1.0 mass % of Mg, 0.3 to 1.0 mass % of Si, and 0.01 to 0.2 mass % of Cu, with the balance being Al and inevitable impurities, which has a recrystallized texture of 40% or more of an area ratio of grains each having a (111) plane and being positioned in parallel to a cross-section vertical to a wire-drawing direction of a wire, and
which has a grain size of 1 to 30 μm on the cross-section vertical to the wire-drawing direction of the wire.

17. The aluminum alloy conductor according to claim 16, which has the recrystallized texture of 25% or more of the area ratio of grains each having a (111) plane and being positioned in parallel to the cross-section vertical to the wire-drawing direction of the wire, and of 25% or more of an area ratio of grains each having a (112) plane and being positioned in parallel to the cross-section vertical to the wire-drawing direction of the wire, in an area formed by removing, from the entirety of the wire, a portion included in a circle with a radius of (9/10)R from the center of the wire on the cross-section vertical to the wire-drawing direction of the wire, in which R is a radius of the wire.

18. A method of producing an aluminum alloy conductor, comprising:
subjecting an aluminum alloy material which has a composition consisting of: 0.01 to 0.5 mass % of Fe, 0.3 to 1.0 mass % of Mg, 0.3 to 1.0 mass % of Si, and 0.01 to 0.2 mass % of Cu, with the balance being Al and inevitable impurities, to the steps comprising:
[1] melting;
[2] casting with a cooling speed of 1 to 20° C./sec;
[3] hot- or cold-working;
[4] wire drawing with a working degree from 1 to 6;
[5] intermediate annealing at 300 to 450° C., for 10 min or more;
[6] wire drawing with a working degree from 1 to 6; and
[7] finish annealing,
wherein the finish annealing [7] is conducted by a continuous running heat treatment that is a continuous heat treatment comprising the steps of: rapid heating, and quenching, in which an annealing furnace temperature z (° C.) and an annealing time period x (sec) satisfy relationships of:
1.5≦x≦5, and
−50x+550≦z≦−36x+650, and
wherein the thus-produced aluminum alloy conductor has a recrystallized texture of 40% or more of an area ratio of grains each having a (111) plane and being positioned in parallel to a cross-section vertical to a wire-drawing direction of a wire, and has a grain size of 1 to 30 μm on the cross-section vertical to the wire-drawing direction of the wire.

19. The method of producing according to claim 18, wherein the thus-produced aluminum alloy conductor has the recrystallized texture of 25% or more of the area ratio of grains each having a (111) plane and being positioned in parallel to the cross-section vertical to the wire-drawing direction of the wire, and of 25% or more of an area ratio of grains each having a (112) plane and being positioned in parallel to the cross-section vertical to the wire-drawing direction of the wire, in an area formed by removing, from the entirety of the wire, a portion included in a circle with a radius of (9/10)R from the center of the wire on the cross-section vertical to the wire-drawing direction of the wire, in which R is a radius of the wire.

20. The method of producing according to claim 18, wherein the wire drawing [6] is conducted at a wire-drawing speed of 500 to 2,000 m/min.
